(19) United States
(12) Patent Application Publication
(10) Pub. No.: US 2008/0301965 A1
(43) Pub. Date: Dec. 11, 2008

(54) CUTTING BOARD WITH INTEGRAL CUTTING GUIDE

(76) Inventor: KIMBERLY A. TAYLOR, KETCHUM, ID (US)

Correspondence Address: DYKAS, SHAVER & NIPPER, LLP, P.O. BOX 877, BOISE, ID, 83701-0877, US

(21) Appl. No.: 11/760,165

(22) Filed: Jun. 8, 2007

(51) Int. Cl. B43L 7/00; B23Q 3/00

(52) U.S. Cl. 33/566; 269/289 R

(57) ABSTRACT

A cutting board having a number of integral cutting guide lines for assisting an operator (chef) of a knife in cutting a foodstuff (e.g., vegetables) into uniform pieces of at least one predetermined size.

### FIELD OF THE INVENTION

The present invention generally relates to cutting boards, and more particularly relates to cutting boards having integral cutting guides configured for assisting an operator of a knife in cutting a foodstuff into uniform pieces of at least one predetermined size, for instance the size required by a recipe.

### BACKGROUND OF THE INVENTION

The use of what is commonly referred to as a “cutting board” is common in kitchens today, both in commercial kitchens and household kitchens. A cutting board is nothing more than a slab of material upon which a cook can cut and otherwise prepare foodstuffs.

Originally, cutting “boards” were manufactured of a slab of wood. While wood cutting boards are still common, cutting boards of other materials, including but not limited to plastics, glass, ceramics, composites, and silicones are also common. Common sizes of cutting board include, but are not limited to, eleven inches by fourteen inches and twelve inches by sixteen inches. As for thickness, cutting boards can be thick (one inch or more) or thin (thin cutting mats a fraction of an inch thick are common today).

Cutting boards are used for a number of different reasons. For instance, the use of a cutting board protects the countertop surface from damage caused by cutting instruments, such as knives. If a cutting board is not used, the knife can score and nick countertop surface, thereby damaging its finish.

Another reason cutting boards are used is to provide a cutting support surface softer than the knife itself, thereby allowing the knife to cut through the foodstuff without overly dulling or otherwise damaging the knife. For instance, if a cook were to chop vegetables on a granite countertop, the granite would not only become damaged, but would (due to its hardness) itself dull and damage the knife's cutting surface.

Cutting boards are also used to maintain kitchen sanitation. For instance, rather than cutting certain foodstuffs (e.g., raw poultry) on a countertop that is also used in aspects of the cooking process, a cutting board is used. By limiting the kitchen's potential contamination to the cutting board (rather than the entire countertop surface), the chances of cross-contamination are decreased and cleanup (of potential contamination) is made simpler (e.g., the “contaminated” cutting board can be moved off of the preparation surface and sanitized in the normal manner (placed into a dishwasher)) without the entire preparation surface needing to be sanitized.

### SUMMARY OF THE INVENTION

One particular embodiment of the present invention comprises a cutting board having an integral cutting guide for assisting an operator (chef) of a knife in cutting a foodstuff (e.g., vegetables) into uniform pieces of at least one predetermined size (for instance, to the size required by a recipe). This cutting board comprising a planar element having a substantially flat top surface, a first side opposite a second side and a first end opposite a second end. The top surface is configured for supporting said foodstuff while the chef cuts the foodstuff.

The top surface has a plurality of generally parallel cutting guide lines that are visible thereon/therein. These cutting guide lines defining there-between a plurality of predetermined size measurement guides. A label or key may be present for the purpose of indicating to the chef the predetermined size represented by the lines (the measurement guides there-between). In use, the chef can align the foodstuff generally perpendicular to said cutting guide lines and cut the foodstuff into generally uniform pieces of a predetermined size (the width of the predetermined size measurement guides, e.g. ½-inch, 1-inch, 1½-inches and 2-inches) by cutting along the cutting guides.

In this particular embodiment, the cutting guide lines are not parallel or perpendicular to said first side, said second side, said first end or said second end, but are instead arranged at an ergonomic angle there-to.

### BRIEF DESCRIPTION OF THE DRAWINGS

FIG. 1 is a plan view of a first side of a first embodiment of the present invention.

FIG. 2 is a plan view of a second side of the embodiment of FIG. 1.

FIG. 3 is a perspective view of the embodiment of FIG. 1.

FIG. 4 is a perspective view of a second embodiment of the present invention shown in use, wherein a knife is used to cut a foodstuff into pieces.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed herein, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

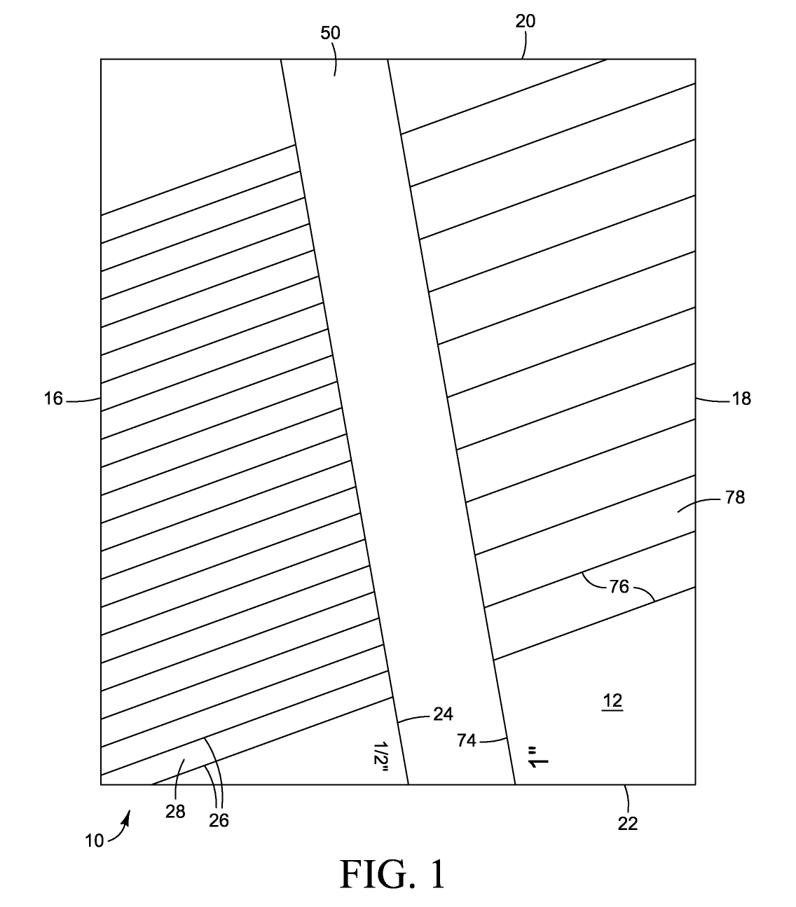

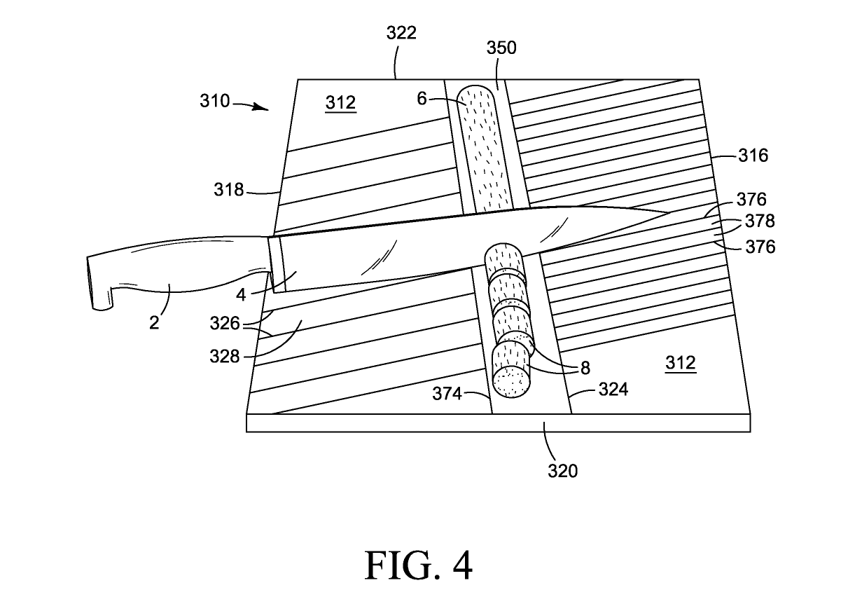

The present invention is a cutting board with integral cutting guides. Two embodiments of the present invention are shown in the figures. FIGS. 1-3 show a first embodiment of the present invention, whereas FIG. 4 shows a second embodiment of the present invention.

One purpose of the integral cutting guide is for assisting an operator of a knife (chef) in cutting a foodstuff into uniform pieces of at least one predetermined size. Many times recipes require that foodstuffs be cut into a predetermined size, for instance a recipe may call for cutting carrots into ½-inch cubes. Over time, professional chefs are trained to quickly estimate lengths. However, for the home chef, estimation has always been problematic, either resulting in the home chef making a rough estimate regarding length or requiring a home chef to utilize a separate ruler or measuring device (which itself brings sanitation and cleanup issues to bear). Embodiments of the present invention resolve this problem for home chefs.

Referring initially to FIG. 1, shown is a first embodiment of the present invention. The invented cutting board 10, having a first face or surface 12, a first side 16, a second side 18, a first end 20 and a second end 22.

The composition of the cutting board can be any material that is conducive to cutting and preparing food on, but most preferably would be a plastic (e.g., HDPE, TPR, etc.) or silicone. The material is preferably manufactured of food grade material that is sterilizable and dishwasher safe. Such material preferably meeting FDA and Federal specifications, National Sanitation Foundation specifications, accepted by the U.S. and Canadian departments of Agriculture. Optionally, the board would have antibacterial properties.

The “cutting board” could likewise be a disposable sheet of material (e.g., plastic, parchment paper, wax paper, foil, etc.) that is used upon an existing cutting board.

The embodiment shown in FIGS. 1-3, being generally rectangular in shape, having opposing parallel sides (16-18, 20-22). Such a rectangular shape is common with cutting boards in general. While such a shape is shown in this embodiment, as well as in the second embodiment of the invention disclosed herein, other shapes are likewise possible, including but not limited to, circular shapes, oval shapes, triangular shapes, etc.

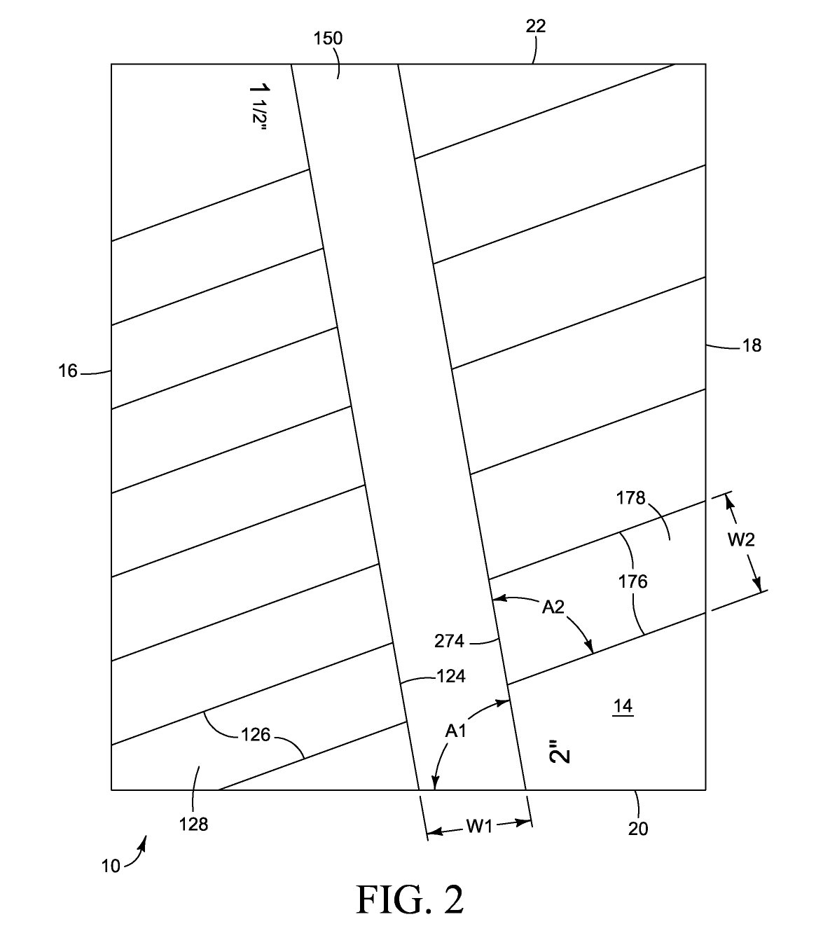

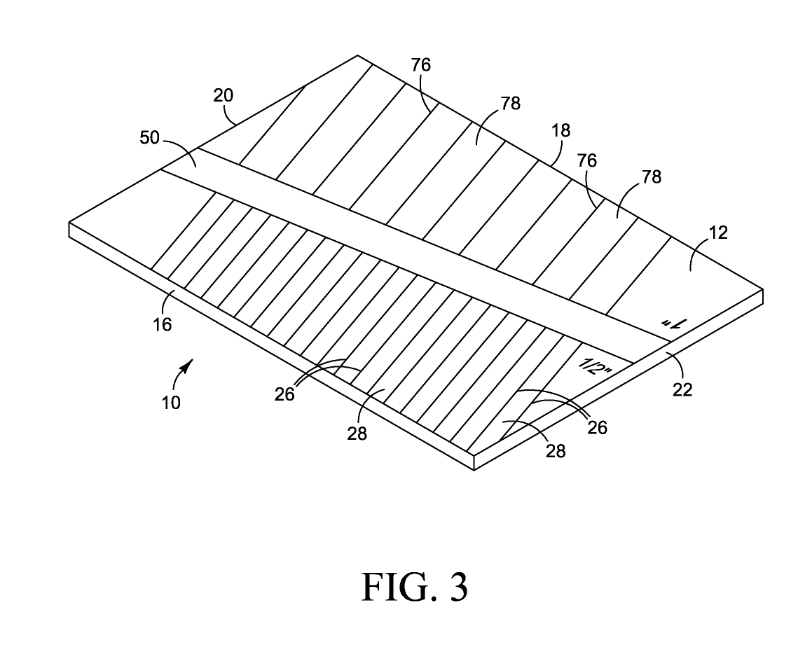

FIG. 1 shows the first face or surface 12, whereas FIG. 2 shows the second face or surface 14, these two faces (12, 14) comprising opposite sides of the same cutting board 10. FIG. 3 shows a perspective view of the embodiment of FIG. 1. While the provision of a double sided board is one preferred embodiment, it is likewise possible that the opposite face of a particular embodiment could be plain and not bear markings such as is shown in the drawings.

Extending generally from the first end 20 to the second end 22 of the first face 12, is preferably at least one center line, for instance the first center line 24. While in the embodiment shown, this center line extends all the way from the first end to the second end, it is expressly envisioned that the line could terminate prior to its junction with one of both of the ends.

This first center line 24 is preferably oriented at an angle to the first and second ends rather than being perpendicularly oriented. In the embodiment shown this center line extends generally eighty-degrees to the first and second ends. While eighty-degrees is shown, other angles are likewise possible, with seventy-five to ninety degrees being most preferred. This center line oriented at an angle for ergonomic purposes, making the cutting board's use more ergonomic for the user.

Also, the board could be configured to be “left-handed” or “right-handed.” The embodiment shown in the drawings is best configured for a right-handed person. A left-handed model would be a general mirror image.

In the embodiment shown, a first center line 24 exists as does a second center line 74. Both center lines, in this embodiment, being generally parallel to one another and spaced apart from one another. These two center lines thereby defining there-between a foodstuff guide portion 50. Such a foodstuff guide portion 50 is preferred, but may or may not be present in a particular embodiment of the present invention. The foodstuff guide portion could also be decorative, having, for instance, a picture of a food item laminated there-to.

It is preferred that a plurality of cutting guide lines 26 extend generally from the plane of the first side 16 to the first center line 24. These cutting guide lines being regularly spaced apart a predetermined distance, preferably regularly. As such, adjacent cutting guide lines 26 defining there-between a cutting guide 28. While it is preferred that the cutting guide line be spaced apart a regular predetermined distance, it is also possible that a mixture of predetermined distances may be utilized or that a series (e.g., ten ½-inch cutting guides followed by five 1-inch cutting guides) by be utilized. These first cutting guide lines 26 and cutting guides 28 located on the board nearer the first side 16 than the second side 18 in this embodiment.

Preferably, at least two cutting guide lines 76 generally extend from the second side 18 to the second center line 74 thereby defining between them a cutting guide 78. These second cutting guide lines 76 and cutting guides 78 located on the board nearer the second side 18 than the first side 16 in this embodiment.

While the provision of center lines is preferred, they may or may not be necessarily present in a particular embodiment of the present invention. Likewise, only a single center line could be provided, with both the first and second cutting guide lines extending there-from (on either side).

In the embodiment shown in FIG. 1, the cutting guide lines 26 are spaced apart ½-inch, thereby defining cutting guides 28 with a general width of ½-inch. In the embodiment shown in FIG. 1, the cutting guide lines 76 are regularly spaced 1-inch apart, thereby defining cutting guides 78 which are 1-inch wide.

While the embodiments shown in the figures show the cutting guide lines extending from the center lines to the sides, it is expressly envisioned that these lines may terminate before their junction with the ends thereof, for instance, one or more of the cutting guide lines may not extend all the way to the first center line, or they may not extend all the way to the first side or edge of the cutting board.

While this disclosure discusses these lines (e.g., first center line, cutting guide lines, second center line, etc.) as being “lines,” such “lines” could be of many forms, including being solid, dotted, symbols, colors, etc. Further, the lines may overlap, creating different colors and/or measurements. For instance, overlapping solid stripes of different colors could be used to create the measurements.

Structurally, such “integral” lines could be variously formed (e.g., scored into the cutting board, ink or other marking material applied to the cutting board's surface, could be embossed into the cutting board's surface or ridges/bumps protruding from the cutting board's surface, could be present on a layer in the cutting board visible but underlying the surface layer, could be a separate type of material that is embedded in the cutting board, etc.).

FIG. 2 shows the opposite side of the cutting board 10 (opposite to what is shown in FIGS. 1 and 3). This figure showing the second face/surface 14. The cutting board 10 having, again, a first side 16, a second side 18, a first end 20 and a second end 22. The second face 14 having 1½-inch and 2-inch cutting guides (128, 178) defined therein. Also shown is a first center line 124 extending from the first end 20 to the second end 22, and a second center line 274 extending from the first end 20 to the second end 22. Extending from the plane of the first side 16 generally to the first center line 124 are a plurality of cutting guide lines 126. These cutting guide lines 126 (1½ inches apart) defining there-between cutting guides 128 that are 1½ inches wide.

The second side of the board 10 further having a second center line 274 extending from the first end 20 to the second end 22. This second center line 274 intersecting with a plurality of cutting guide lines 176 extending generally from the plane of the second side 18 back to the second center line 174. Adjacent cutting guide lines 176 defining there-between a cutting guide 178, which is also shown as the measurement W2.

The measurement W1 representing the foodstuff guide portion 150 that is defined between the first center line 124 and the second center line 274. Preferably, the foodstuff guide portion is between 1-inch and 3-inches wide, more preferably between 1½-inches and 2-inches wide.

Angles are specifically called out in this figure as well, as discussed above, the angle A1 is defined between the second center line 274 and the first end 20. The preferred measurement of angle A1 is eighty degrees. The second angle shown in this view is angle A2, which is the angle between the second center line 274 and its intersection with the cutting guideline 176. This angle being generally eighty degrees as well. While eighty degrees is the preferred angle shown in these embodiments, other angles will likewise work. The inventor using eighty degrees because it is the angle she personally feels is best ergonomically. Obviously, other angles may be better and/or more ergonomic and are considered hereby disclosed herein.

Referring now to FIG. 4, shown is a second embodiment of the present invention. This figure showing a cutting board 310 having a first face 312, a first side 316, a second side 318, a first end 320 and a second end 322. A first center line 374 is defined extending from the first end to the second end. A second center line 324 is defined extending from the first end to the second end. The space therebetween the first center line 374 and the second center line 324 is a foodstuff guide portion 350. Again, as discussed above, utilization of such a foodstuff guide portion is optional.

Extending from the first center line 374 back generally to the plane of the second side 318 are a plurality of cutting guide lines 326 defining there-between a plurality of cutting guides 328. Extending from the second center line 324 back generally to the plane of the first side 316 are a plurality of cutting guide lines 376 defining there-between a plurality of cutting guides 378. These cutting guide lines 326 (376) being spaced apart a predetermined distance so that when a foodstuff is placed with the axis thereof aligned to be generally parallel to one or both of the center lines, knife strokes (e.g., slices, strokes, chops) in alignment therewith result in the cutting of the foodstuff 6 into one or more predetermined sized pieces 8. For instance, if in this embodiment the cutting guide 328 was generally 1-inch in width, the pieces 8 cut would themselves would be generally 1-inch long. Optionally, the cut line could be made in a manner other than the perpendicular to the foodstuff's axis, for instance bias cuts could be made.

First example embodiment. A cutting board with integral cutting guide for assisting an operator of a knife in cutting a foodstuff into uniform pieces of at least one predetermined size. The cutting board comprising a planar element having a substantially flat top surface, a first side opposite a second side and a first end opposite a second end. The top surface configured for supporting the foodstuff while the operator cuts the foodstuff. The top surface comprising a plurality of generally parallel cutting guide lines defining there-between a plurality of predetermined size measurement guides (e.g., ½-inch, 1-inch, 1½-inches and 2-inches). Whereby the operator can align said foodstuff generally perpendicular to the cutting guide lines and manipulate the knife in a cutting motion along the cutting guides so as to cut the foodstuff into uniform pieces of predetermined size. Preferably, the cutting guide lines are not parallel or perpendicular to the first side, second side, first end or second end.

Second example embodiment. A cutting board with two integral cutting guides for assisting an operator of a knife in cutting a foodstuff into uniform pieces of at least one predetermined size. The cutting board comprising a planar element having a substantially flat top surface, a first side opposite a second side and a first end opposite a second end. The top surface configured for supporting the foodstuff while the operator cuts the foodstuff. The top surface comprising a plurality of generally parallel first cutting guide lines defining there-between a plurality of predetermined size first measurement guides.

Whereby the operator can align the foodstuff generally perpendicular to the first cutting guide lines and manipulate the knife in a cutting motion along the first cutting guides so as to cut the foodstuff into uniform pieces of a first predetermined size (e.g., ½-inch, 1-inch, 1½-inches and 2-inches). Wherein the top surface further comprises a plurality of generally parallel second cutting guide lines defining there-between a plurality of predetermined size second measurement guides. The second measurement guides of a different predetermined size measurement than the first measurement guides. Whereby the operator can align the foodstuff generally perpendicular to the second cutting guide lines and manipulate the knife in a cutting motion along the second cutting guides so as to cut the foodstuff into uniform pieces of a second predetermined size (e.g., ½-inch, 1-inch, 1½-inches and 2-inches).

Preferably, the first cutting guide lines are generally parallel to the second cutting guide lines. Preferably, the cutting guide lines are not parallel or perpendicular to the first side, the second side, the first end or the second end. It is also preferred that the measurement guides be of differing predetermined size measurements. Preferably, a foodstuff guide portion is defined between the first cutting guide lines and the second cutting guide lines. The foodstuff guide portion comprising the portion of the top surface configured for supporting the foodstuff while the operator cuts the foodstuff. Preferably, the foodstuff guide portion is between 1-inch and 3-inches wide, more preferably between 1½-inches and 2-inches wide.

Third example embodiment. A double sided cutting board with a pair of integral cutting guides on each side for assisting an operator of a knife in cutting a foodstuff into uniform pieces of at least one predetermined size. The cutting board comprising a planar element having a substantially flat top surface opposite a substantially flat bottom surface, a first side opposite a second side and a first end opposite a second end. The top surface configured for supporting the foodstuff while the operator cuts the foodstuff. The top surface comprising a plurality of generally parallel first cutting guide lines defining there-between a plurality of predetermined size first measurement guides. Whereby the operator can align the foodstuff generally perpendicular to the first cutting guide lines and manipulate the knife in a cutting motion along the first cutting guides so as to cut the foodstuff into uniform pieces of a first predetermined size.

The top surface further comprising a plurality of generally parallel second cutting guide lines defining there-between a plurality of predetermined size second measurement guides. The second measurement guides of a different predetermined size measurement than the first measurement guides. Whereby the operator can align the foodstuff generally perpendicular to the second cutting guide lines and manipulate the knife in a cutting motion along the second cutting guides so as to cut the foodstuff into uniform pieces of a second predetermined size.

The bottom surface configured for supporting the foodstuff while the operator cuts the foodstuff. The bottom surface comprising a plurality of generally parallel third cutting guide lines defining there-between a plurality of predetermined size third measurement guides. The third measurement guides of a different predetermined size measurement than at least one of the first and second measurement guides. Whereby the operator can align the foodstuff generally perpendicular to the third cutting guide lines and manipulate the knife in a cutting motion along the third cutting guides so as to cut the foodstuff into uniform pieces of a third predetermined size.

Wherein the bottom surface further comprises a plurality of generally parallel fourth cutting guide lines defining there-between a plurality of predetermined size fourth measurement guides. The fourth measurement guide of a different predetermined size measurement than at least one of the first, second and third measurement guides. Whereby the operator can align the foodstuff generally perpendicular to the fourth cutting guide lines and manipulate the knife in a cutting motion along the fourth cutting guides so as to cut the foodstuff into uniform pieces of a fourth predetermined size.

Preferably, the first cutting guide lines are generally parallel to the second cutting guide lines. Preferably, the cutting guide lines are not parallel or perpendicular to the first side, the second side, the first end or the second end. Preferably, the third cutting guide lines are generally parallel to the fourth cutting guide lines. Preferably, the cutting guide lines are not parallel or perpendicular to the first side opposite, the second side, the first end or the second end. Preferably, the measurement guides are of differing predetermined size measurements, including but not limited to ½-inch, 1-inch, 1½-inches and 2-inches. Preferably, a foodstuff guide portion (between 1 and 3-inches wide) is defined between the first cutting guide lines and the second cutting guide lines, this foodstuff guide portion comprising the portion of the top surface configured for supporting the foodstuff while the operator cuts the foodstuff.

The purpose of the Abstract of the Disclosure is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A cutting board with integral cutting guide for assisting an operator of a knife in cutting a foodstuff into uniform pieces of at least one predetermined size, said cutting board comprising:
a planar element having a substantially flat top surface, a first side opposite a second side and a first end opposite a second end, said top surface configured for supporting said foodstuff while said operator cuts said foodstuff, said top surface comprising a plurality of generally parallel cutting guide lines, said cutting guide lines defining there-between a plurality of predetermined size measurement guides, whereby said operator can align said foodstuff generally perpendicular to said cutting guide lines and manipulate said knife in a cutting motion along said cutting guides so as to cut said foodstuff into uniform pieces of said predetermined size.

2. The cutting board of claim 1, wherein said cutting guide lines are not parallel or perpendicular to said first side, said second side, said first end or said second end.

3. The cutting board of claim 1, wherein said measurement guide size measurement is selected from the group consisting of ½-inch, 1-inch, 1½-inches and 2-inches.

4. A cutting board with integral cutting guide for assisting an operator of a knife in cutting a foodstuff into uniform pieces of at least one predetermined size, said cutting board comprising:
a planar element having a substantially flat top surface, a first side opposite a second side and a first end opposite a second end, said top surface configured for supporting said foodstuff while said operator cuts said foodstuff, said top surface comprising a plurality of generally parallel first cutting guide lines, said first cutting guide lines defining there-between a plurality of predetermined size first measurement guides, whereby said operator can align said foodstuff generally perpendicular to said first cutting guide lines and manipulate said knife in a cutting motion along said first cutting guides so as to cut said foodstuff into uniform pieces of a first predetermined size;
wherein said top surface further comprises a plurality of generally parallel second cutting guide lines, said second cutting guide lines defining there-between a plurality of predetermined size second measurement guides, said second measurement guides of a different predetermined size measurement than said first measurement guides, whereby said operator can align said foodstuff generally perpendicular to said second cutting guide lines and manipulate said knife in a cutting motion along said second cutting guides so as to cut said foodstuff into uniform pieces of a second predetermined size.

5. The cutting board of claim 4, wherein said first cutting guide lines are generally parallel to said second cutting guide lines.

6. The cutting board of claim 5, wherein said cutting guide lines are not parallel or perpendicular to said first side, said second side, said first end or said second end.

7. The cutting board of claim 6, wherein said measurement guides are of differing predetermined size measurements.

8. The cutting board of claim 4, wherein said measurement guide size measurements are selected from the group consisting of ½-inch, 1-inch, 1½-inches and 2-inches.

9. The cutting board of claim 4, wherein a foodstuff guide portion is defined between said first cutting guide lines and said second cutting guide lines, said foodstuff guide portion comprising the portion of said top surface configured for supporting said foodstuff while said operator cuts said foodstuff.

10. The cutting board of claim 9, wherein said foodstuff guide portion is between 1-½ and 2-inches wide.

11. A cutting board with integral cutting guide for assisting an operator of a knife in cutting a foodstuff into uniform pieces of at least one predetermined size, said cutting board comprising:
a planar element having a substantially flat top surface opposite a substantially flat bottom surface, a first side opposite a second side and a first end opposite a second end;
said top surface configured for supporting said foodstuff while said operator cuts said foodstuff, said top surface comprising a plurality of generally parallel first cutting guide lines, said first cutting guide lines defining there-between a plurality of predetermined size first measurement guides, whereby said operator can align said foodstuff generally perpendicular to said first cutting guide lines and manipulate said knife in a cutting motion along said first cutting guides so as to cut said foodstuff into uniform pieces of a first predetermined size;
wherein said top surface further comprises a plurality of generally parallel second cutting guide lines, said second cutting guide lines defining there-between a plurality of predetermined size second measurement guides, said second measurement guides of a different predetermined size measurement than said first measurement guides, whereby said operator can align said foodstuff generally perpendicular to said second cutting guide lines and manipulate said knife in a cutting motion along said second cutting guides so as to cut said foodstuff into uniform pieces of a second predetermined size;
said bottom surface configured for supporting said foodstuff while said operator cuts said foodstuff, said bottom surface comprising a plurality of generally parallel third cutting guide lines, said third cutting guide lines defining there-between a plurality of predetermined size third measurement guides, said third measurement guides of a different predetermined size measurement than at least one of said first and second measurement guides, whereby said operator can align said foodstuff generally perpendicular to said third cutting guide lines and manipulate said knife in a cutting motion along said third cutting guides so as to cut said foodstuff into uniform pieces of a third predetermined size;
wherein said bottom surface further comprises a plurality of generally parallel fourth cutting guide lines, said fourth cutting guide lines defining there-between a plurality of predetermined size fourth measurement guides, said fourth measurement guide of a different predetermined size measurement than at least one of said first, second and third measurement guides, whereby said operator can align said foodstuff generally perpendicular to said fourth cutting guide lines and manipulate said knife in a cutting motion along said fourth cutting guides so as to cut said foodstuff into uniform pieces of a fourth predetermined size.

12. The cutting board of claim 11, wherein said first cutting guide lines are generally parallel to said second cutting guide lines.

13. The cutting board of claim 12, wherein said cutting guide lines are not parallel or perpendicular to said first side, said second side, said first end or said second end.

14. The cutting board of claim 11, wherein said third cutting guide lines are generally parallel to said fourth cutting guide lines.

15. The cutting board of claim 14, wherein said cutting guide lines are not parallel or perpendicular to said first side opposite, said second side, said first end or said second end.

16. The cutting board of claim 11, wherein said measurement guides are of differing predetermined size measurements.

17. The cutting board of claim 11, wherein said measurement guide size measurements are selected from the group consisting of ½-inch, 1-inch, 1½-inches and 2-inches.

18. The cutting board of claim 11, wherein a foodstuff guide portion is defined between said first cutting guide lines and said second cutting guide lines, said foodstuff guide portion comprising the portion of said top surface configured for supporting said foodstuff while said operator cuts said foodstuff.

19. The cutting board of claim 18, wherein said foodstuff guide portion is between 1-½ and 2-inches wide.

20. The cutting board of claim 11, including a label indicating the predetermined size represented by measurement guides.
